(19) United States
(12) Patent Application Publication
(10) Pub. No.: US 2012/0215364 A1
(43) Pub. Date: Aug. 23, 2012

(54) FIELD LIFT OPTIMIZATION USING DISTRIBUTED INTELLIGENCE AND SINGLE-VARIABLE SLOPE CONTROL

(76) Inventor: David John Rossi, Oxford (GB)

(21) Appl. No.: 13/399,724

(22) Filed: Feb. 17, 2012

Related U.S. Application Data
(60) Provisional application No. 61/444,145, filed on Feb. 18, 2011.

(51) Int. Cl. G05D 9/12

(52) U.S. Cl. 700/281

(57) ABSTRACT

A method, computing device, computer-readable storage medium, and system perform field lift optimization using single-variable slope control, and typically using distributed intelligence between a central controller and individual well controllers to provide lift optimization for the artificial lift mechanisms used by a plurality of wells in an oilfield. An oilfield-wide slope control variable is generated and distributed to the various wells within an oilfield for localized control at each well of the artificial lift mechanism therefor to provide for optimized oil production across an oil field. The oilfield-wide slope control variable is typically used to determine a well-specific lift parameter for each well based upon a well-specific performance curve for the well.

### CROSS-REFERENCE TO RELATED APPLICATION

This application claims the benefit of U.S. Patent Application Ser. No. 61/444,145 filed Feb. 18, 2011, which is incorporated herein by reference in its entirety.

### BACKGROUND

In some oil reservoirs, the pressure inside the reservoir is insufficient to push wellbore fluids to the surface without the help of a pump or other so-called artificial lift technology such as gas lift in the well. With a gas-based artificial lift system, external gas is injected into special gaslift valves placed inside a well at specific design depths. The injected gas mixes with produced fluids from the reservoir, and the injected gas decreases the pressure gradient inside the well, from the point of gas injection up to the surface. Bottomhole fluid pressure is thereby reduced, which increases the pressure drawdown (pressure difference between the reservoir and the bottom of the well) to increase the well fluid flow rate.

Other artificial lift technologies may also be used, e.g., centrifugal pumps such as electro-submersible pumps (ESPs) or progressing cavity pumps (PCPs). Furthermore, with some oil reservoirs, a mixture of artificial lift technologies may be used on different wells.

During the initial design of a gas lift or other artificial lift system to be installed in a borehole, software models have traditionally been used to determine the best configuration of artificial lift mechanisms, e.g., the gas lift valves, in a well, based on knowledge about the reservoir, well and reservoir fluids. However, models that are limited to single wells typically do not take into account the effects of other wells in the same reservoir, and it has been found that the wells coupled to the same reservoir will affect the actual rates experienced by each well.

Software models have also been developed to attempt to optimally configure artificial lift mechanisms for multiple wells coupled to the same reservoir in the same oilfield or surface production network. Such models, which are typically referred to as mathematical surface network models, better account for the interrelationships between wells and the artificial lift mechanisms employed by the various wells. Nonetheless, shortcomings still exist with such multi-well models. For example, a mathematical surface network model is always an approximation to reality, so the computed optimized lift gas rates for a gas-based artificial lift system are an approximation to the true optimum rates. In addition, a mathematical surface network model typically needs to be continually re-calibrated so that it remains an accurate representation of the real network. Online measurements of a surface production network (e.g., actual measurements of pressures, temperatures and flow rates) often must be cross-checked against model calculations to insure that the two are consistent. If they differ substantially, a human operator may be forced to intervene to alter the mathematical surface network model to improve the match. In addition, in some instances a mathematical surface network model must be re-run whenever surface network conditions change, that is, whenever the well head flowing back pressures change, so that optimized lift gas rate values change. Surface network conditions can change frequently, for example, in response to instantaneous changes in the surface facility settings, equipment status and availability (equipment turning on and off), changes in ambient temperature, and at slower time scales, changes in fluid composition such as gas-oil ratio and water cut and surface network solid buildup or bottle-necking.

Moreover, another problem arising as a result of the use of mathematical surface network models is the need for centralized computation or determination of optimal artificial lift parameters for wells in a surface network. Often, set points for individual well gas lift values are calculated by a central controller and communicated to the individual wells, where closed loop controllers maintain the desired set points, independent of any feedback or other operating conditions being experienced by the wells. As such, the centralized nature of the model calculations is not particularly responsive to the actual conditions for each well.

Therefore, a need continues to exist in the art for an improved manner of optimizing artificial lift technologies for multiple wells in a multi-well production network.

### SUMMARY

The invention addresses these and other problems associated with the prior art by providing one or more of a method, computing device, computer-readable storage medium, and system for performing field lift optimization using single-variable slope control, and typically using distributed intelligence between a central controller and individual well controllers to provide field-wide lift optimization. Single-variable slope control, within this context, incorporates the generation and distribution of an oilfield-wide slope control variable to the various wells within an oilfield for localized control at each well of the artificial lift mechanism to provide for optimized oil production across an oil field. The oilfield-wide slope control variable is typically used to determine a well-specific lift parameter for each well based upon a well-specific performance curve for the well.

Consistent with one aspect of the invention, for example, field lift optimization is performed by causing at least one well among a plurality of wells in an oilfield to control a lift parameter associated with an artificial lift mechanism for the well in response to an oilfield-wide slope control variable, where the oilfield-wide slope control variable is usable to determine the lift parameter based upon at least one well-specific performance curve for the well.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIGS. 1A-1D illustrate simplified, schematic views of an oilfield having subterranean formations containing reservoirs therein in accordance with implementations of various technologies and techniques described herein.

FIG. 2 illustrates a schematic view, partially in cross section of an oilfield having a plurality of data acquisition tools positioned at various locations along the oilfield for collecting data from the subterranean formations in accordance with implementations of various technologies and techniques described herein.

FIG. 3 illustrates a production system for performing one or more oilfield operations in accordance with implementations of various technologies and techniques described herein.

FIG. 4 illustrates a chart in accordance with implementations of various technologies and techniques described herein.

FIG. 5 illustrates a schematic illustration of embodiments in accordance with implementations of various technologies and techniques described herein.

FIG. 6 illustrates a flow chart in accordance with implementations of various technologies and techniques described herein.

FIG. 7 illustrates a schematic illustration of embodiments in accordance with implementations of various technologies and techniques described herein.

FIG. 8 illustrates a flowchart in accordance with implementations of various technologies and techniques described herein.

FIG. 9 illustrates a chart in accordance with implementations of various technologies and techniques described herein.

FIG. 10 illustrates a chart in accordance with implementations of various technologies and techniques described herein.

FIG. 11 illustrates a chart in accordance with implementations of various technologies and techniques described herein.

FIG. 12 illustrates a chart in accordance with implementations of various technologies and techniques described herein.

FIG. 13 illustrates a chart in accordance with implementations of various technologies and techniques described herein.

FIG. 14 illustrates a flowchart in accordance with implementations of various technologies and techniques described herein.

FIG. 15 illustrates a flowchart in accordance with implementations of various technologies and techniques described herein.

FIG. 16 illustrates a computer system into which various technologies and techniques described herein may be implemented.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

Embodiments consistent with the invention are generally directed to performing field lift optimization for a plurality of wells in an oilfield, where each well includes an artificial lift mechanism, e.g., using gas lift mechanisms, centrifugal pumps such as electro-submersible pumps (ESPs) or progressing cavity pumps (PCPs), etc.

Such embodiments utilize single-variable slope control, and typically using distributed intelligence between a central controller and individual well controllers to provide field-wide lift optimization. Single-variable slope control, within this context, incorporates the generation and distribution of an oilfield-wide slope control variable to the various wells within an oilfield for localized control at each well of the artificial lift mechanism to provide for optimized oil production across an oil field.

It has been found, in particular, that over a set of wells in an oilfield and coupled to the same surface production network, the slopes of the performance curves for such wells (i.e., curves that characterize oil production relative to a lift parameter, such as lift gas rate, used to control an artificial lift mechanism) are substantially the same at optimum conditions, as otherwise it would be possible, e.g., in the case of a gas lift mechanism, to reassign lift gas from one well to another well having a larger slope and increase field-wide oil production using the same amount of lift gas. As such, the use of an oilfield-wide control variable based upon performance curve slope enables lift parameters, e.g., lift gas rates, or other parameters specific to different types of artificial lift mechanisms, to be locally determined at each well based upon the performance curves particular to that well (well-specific performance curves), and in particular, based upon derivatives of such performance curves.

An oilfield-wide slope control variable, in this regard, may refer to a control variable capable of being used to generate a lift parameter for a particular well based upon one or more well-specific performance curves for a well, e.g., by matching the control variable to a derivative performance curve associated with a current well pressure parameter, e.g., a current well head flowing pressure for the well.

It will be appreciated that in various embodiments of the invention, an oilfield-wide slope control variable may be used to cause a well in an oilfield to control a lift parameter associated with an artificial lift mechanism for that well. Such causation may occur, for example, as a result of a central controller or other computing device that is separate from a well controller generating and communicating the oilfield-wide slope control variable to the well controller, given that the communication of the oilfield-wide slope control variable will typically induce the well controller to effect the desired control of its associated artificial lift mechanism. In addition, such causation may occur, for example, as a result of a well controller controlling an artificial lift mechanism in response to either local generation or receipt of the oilfield-wide slope control variable by the well controller.

It will further be appreciated that the allocation of functionality between a central, oilfield-wide controller and one or more well controllers may vary from the allocation of functionality found in the embodiments disclosed specifically herein. In some embodiments, for example, a central controller may also function as a well controller, while in other embodiments, well controllers may independently calculate the oilfield-wide slope control variable. In still other embodiments, a central controller may calculate and communicate well-specific lift parameters to each of the wells based upon the oilfield-wide slope control variable. Still other embodiments may be envisioned, and as such, the invention is not limited to the particular embodiments disclosed herein.

In one exemplary embodiment discussed hereinafter, for example, where wells in an oilfield utilize gas lift mechanisms, such that the lift parameter being controlled is a lift gas rate, causing a well to control a lift parameter may include, from the perspective of a central controller, determining an oilfield-wide slope control variable by, for each well, determining a performance curve slope for a performance curve for a given well head flowing pressure for such well over a range of lift gas rates, mapping an oil production rate and a lift gas rate against the performance curve slope to generate well-specific oil production rate vs. slope and lift gas rate vs. slope curves, summing the well-specific oil production rate vs. slope and lift gas rate vs. slope curves for the plurality of wells to generate oilfield-wide oil production rate vs. slope and lift gas rate vs. slope curves, cross-plotting oilfield-wide oil production rate against oilfield-wide lift gas rate using the oilfield-wide oil production rate vs. slope and lift gas rate vs. slope curves to generate a cross-plot, and determining the oilfield-wide slope control variable from the cross-plot, the oilfield-wide oil production rate vs. slope curve, the oilfield-wide lift gas rate vs. slope curve, the well-specific well oil production rate vs. slope curves and the well-specific lift gas rate vs. slope curves to optimize field-wide oil production rate based upon at least one field-level lift gas restraint.

In addition, from the perspective of the individual well controllers, the oilfield-wide slope control variable may be received from the central controller and used to determine a well-specific lift gas rate for an associated well by interpolating a stored set of gas lift performance curves for the associated well based upon a well head flowing pressure for the associated well to determine a current lift performance curve, numerically differentiating the current lift performance curve to determine a performance curve slope at a plurality of points on the current lift performance curve and thereby generate a derivative performance curve, and determining the well-specific lift gas rate from the derivative performance curve based upon the oilfield-wide slope control variable.

Other modifications will be apparent to one of ordinary skill in the art, and the invention is therefore not limited to the particular embodiments disclosed herein.

### Oilfield Operations

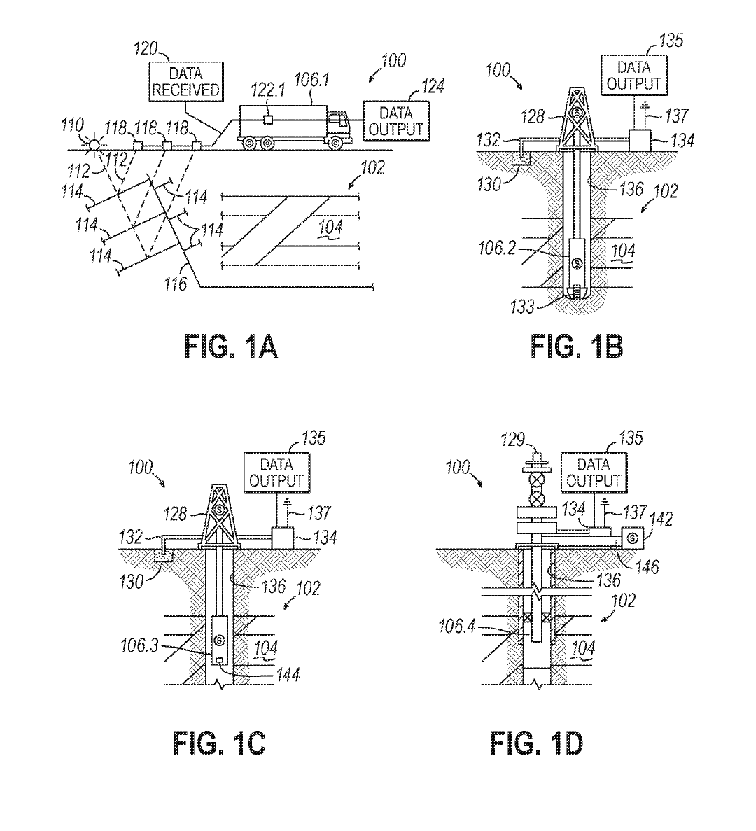

FIGS. 1A-1D illustrate simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106.1, to measure properties of the subterranean formation. The survey operation is a seismic survey operation for producing sound vibrations. In FIG. 1A, one such sound vibration, sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is usually filtered and returned to the mud pit. A circulating system may be used for storing, controlling, or filtering the flowing drilling muds. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produces data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize portions of the field operation, such as controlling drilling, weight on bit, pump rates, or other parameters. These adjustments may be made automatically based on computer protocol, and/or manually by an operator. In some cases, well plans may be adjusted to select optimum operating conditions or to avoid problems.

FIG. 1C illustrates a wireline operation being performed by wireline tool 106.3 suspended by rig 128 and into wellbore 136 of FIG. 1B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 1D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage, or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part, or all, of oilfield 100 may be on land, water and/or sea. Also, while a single field measured at a single location is depicted, oilfield applications may be utilized with any combination of one or more oilfields, one or more processing facilities and one or more wellsites.

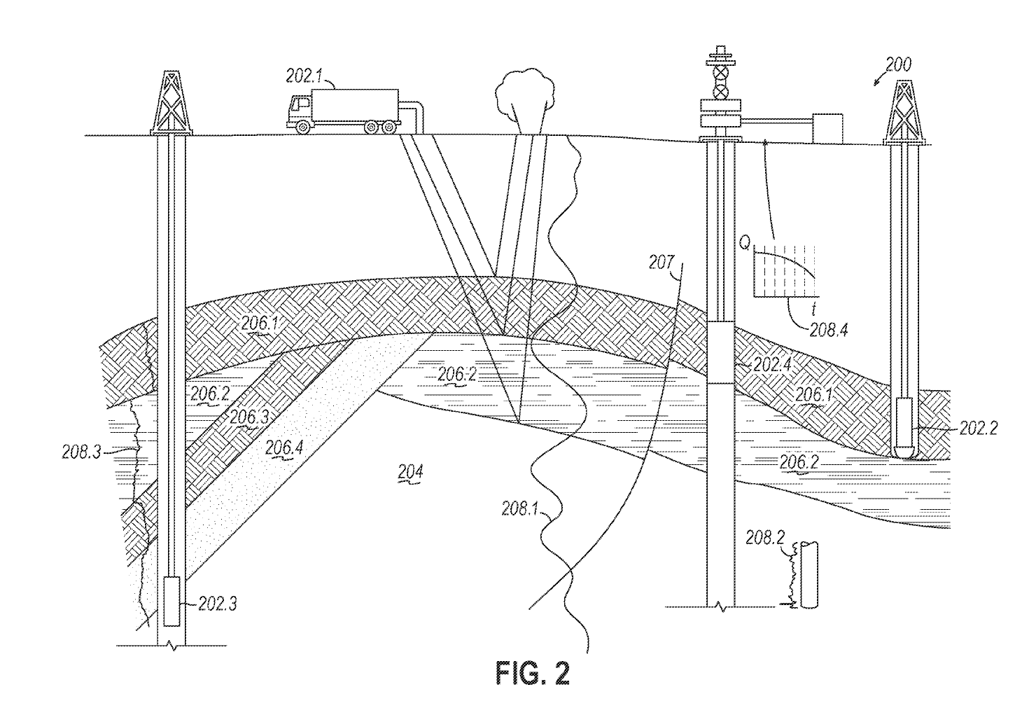

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1A-1D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively, however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208.1 from data acquisition tool 202.1 is used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

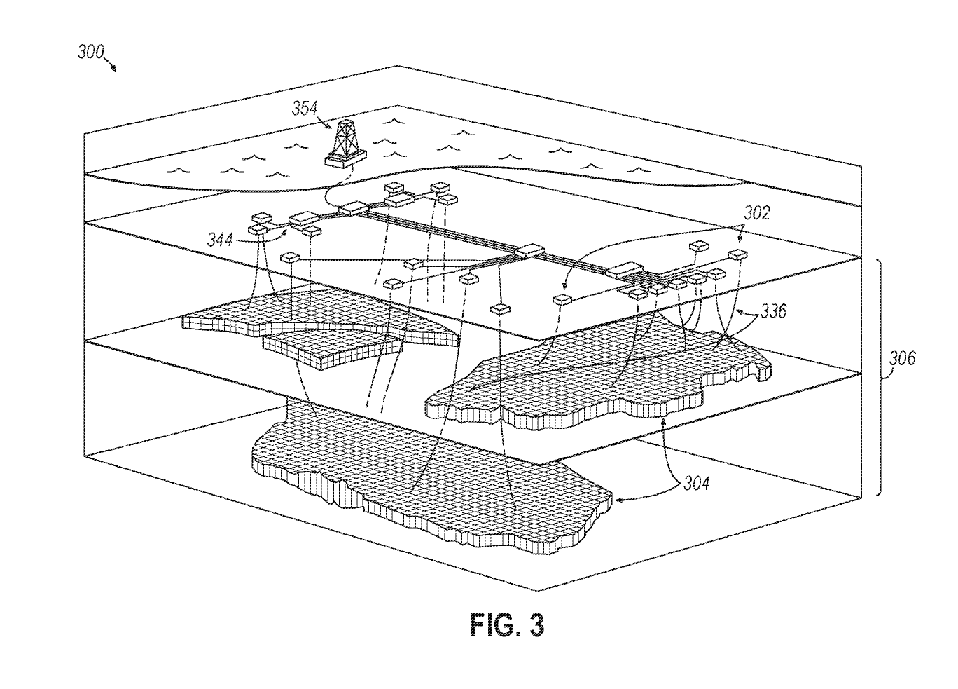

FIG. 3 illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3 is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms a wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

### Gas Lift Well Performance Curves

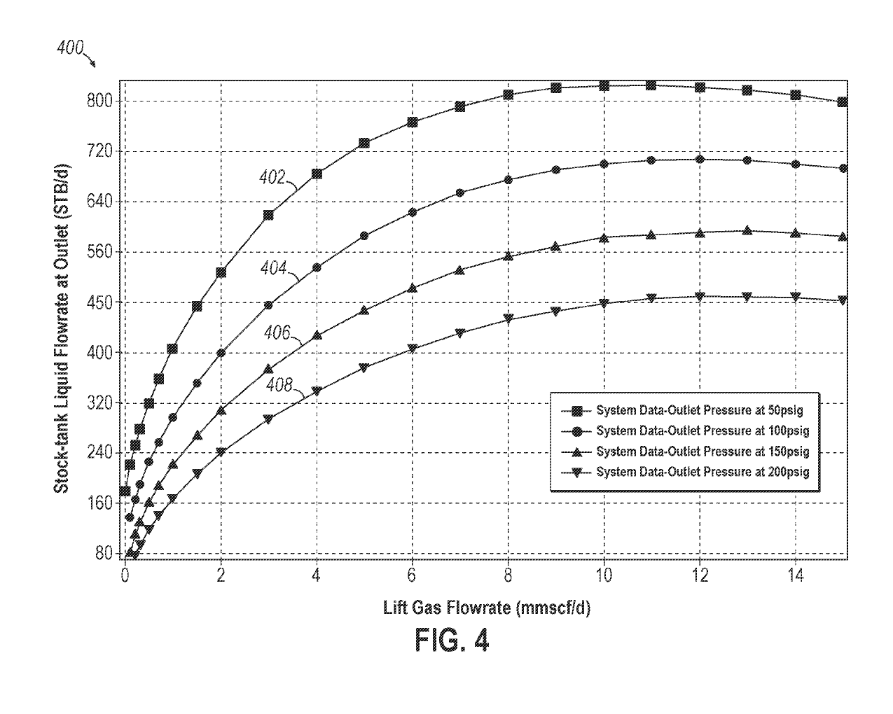

Each gas-lifted well can be thought of a having one input (lift gas) and one output (produced liquid). For each well, the gas lift well model that was created during the initial step of designing the gas lift completion may used to compute gas lift well performance curves, as illustrated conceptually in FIG. 4 at 400. Each gas lift well performance curve indicates the output wellbore production liquid flow rate versus the input injected lift gas flow rate; a family of performance curves will be computed for a set of wellhead flowing pressures (i.e., the surface network back-pressure against which the well produces). For a given value of injected lift gas flow rate, a higher value of wellhead flowing pressure (higher back-pressure) results in a smaller wellbore production liquid flow rate. More particularly, the gas lift well performance curves include a first performance curve 402 illustrating the output wellbore production liquid flow rate with a wellhead flowing pressure at 50 psig, a second performance curve 404 illustrating the output wellbore production liquid flow rate with a wellhead flowing pressure at 100 psig, a third performance curve 406 illustrating the output wellbore production liquid flow rate with a wellhead flowing pressure at 150 psig, and a fourth performance curve 408 illustrating the output wellbore production liquid flow rate with a wellhead flowing pressure at 200 psig.

### Gas Lift Surface Network

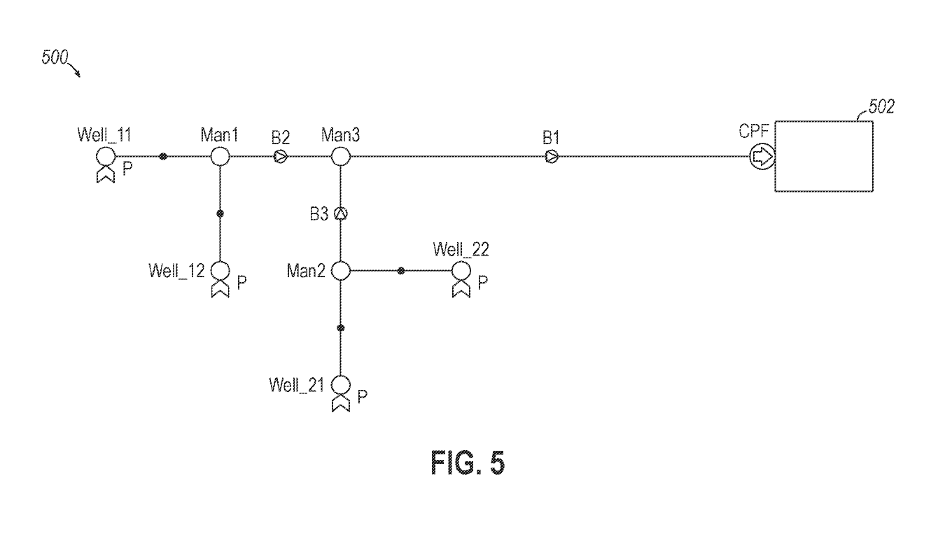

In a field comprising N gas lifted wells, the outputs of the N wells flow into a production network, e.g., a surface production network. By way of example, a production network model with four wells (“Well_11,” “Well_12,” “Well_13” and “Well_14”) is shown in FIG. 5 at 500. The production network may include a series of surface flow lines that collect the liquid production from the wells and gather it at a production facility 502 that may, for example, separate the oil, water and gas phases. Because the wells are inter-connected through the production network 500, the production from one well can influence or interfere with the production from another well. For example, if one well's production rate increases to a high value, this may elevate the pressure in the production network 500 and result in production in other wells of the production network 500 to decrease. Addressing the interaction of pressure through the production network 500 makes field-wide system optimization more difficult than optimizing a single well.

### Online Measurements

During certain field operations, several measurements are made for gas lifted wells, and may be repeated at predetermined intervals:

1. Injected lift gas pressure and flow rate (which, in some embodiments, is measured daily)

2. Well production liquid flow rate, gas-oil ratio (GOR) and water cut (i.e., ratio of water flow rate to liquid flow rate, which is typically taken during occasional well tests, e.g., every few weeks)

3. Wellhead flowing temperature and pressure P_{wf} (which, in some embodiments, is measured daily)

4. Static reservoir pressure (which may be measured hourly, daily or weekly from pressure transient analysis of well shut-in pressure data).

In some or all embodiments, these measurements are used to determine how to control a production network 500 to achieve a particular production target.

Field-Wide Optimization of Gas Lifted Wells with System Constraints

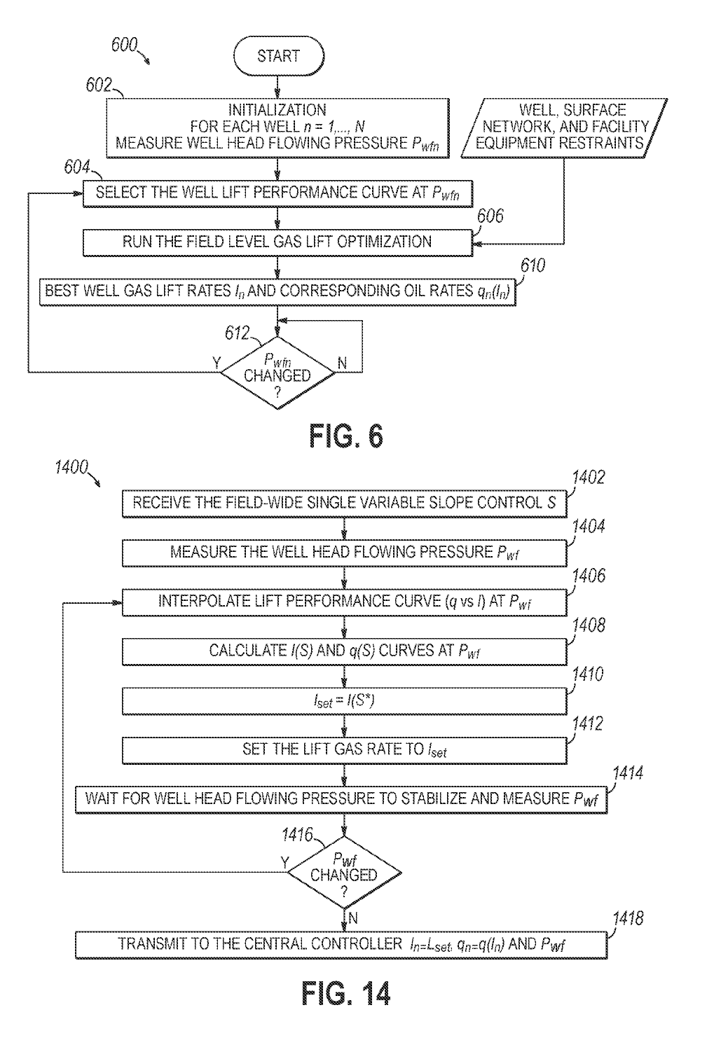

In some embodiments, the gas lift well performance curves 402-408 for a well (FIG. 4) is used to compute the optimum operating point for that well. When gas supply is unlimited, an optimum operating point for a well is typically at the maximum value of the curve for the current tubing head pressure (which itself depends on the production from neighboring wells due to network back-pressure effects). In the more general case where lift gas supply is limited, an optimization problem may be solved that computes the amount of lift gas to inject into each gas lifted well in order to maximize the overall oil production from the field. FIG. 6, for example, is a flowchart 600 illustrating a method of determining the amount of lift gas to inject into a gas lifted well in order to maximize the overall oil production from a field.

In some embodiments, the total amount of gas available from the gas facilities for field-wide lift is constrained to be no more than some maximum amount L_{MAX}. This may reflect, for example, equipment limits on gas separation or gas compression. If there are N gas lifted wells in the field, the following notation may be used:

lₙ denotes the gas lift rate into well n=1, 2, . . . , N

qₙ(lₙ) denotes the oil production rate from well n=1, 2, . . . , N

Note that in the last line the oil production rate of well n is a function of the gas lift rate of well n. Specifically, the oil production rate is given by the well oil cut multiplied by the well liquid rate, where the well liquid rate is a function of the well gas lift injection rate through the appropriate gas lift well performance curve at wellhead flowing pressure P_{wf} as illustrated in FIG. 4.

Knowing the gas lift performance curves for each well and the total available injection gas L_{MAX}, a candidate set of well gas lift rates qₙ that maximize the field oil production rate are provided by the solution to the following optimization problem:

$${max}_{{l}_{n}} {\sum }_{n = 1}^{N} {q}_{n} ( {l}_{n} ) \qquad ( Eq 1 a )$$

subject to the constraint

$${\sum }_{n = 1}^{N} {l}_{n} \leq {L}_{MAX} \qquad ( Eq 1 b )$$

Returning to FIG. 6, the optimization computation initializes by making a measurement of the well head flowing pressure P_{wf} for each well (block 602). This value is used to identify and select which well performance curve (out of the family of curves illustrated in FIG. 4 as at 402-408) corresponds to the current well condition (block 604). In some embodiments, when a curve is not available for the specific value of measured well head pressure, a curve is computed through interpolation from the two curves nearest to the measured value at block 604). In response to selecting, identifying, or computing a well left performance curve, the field-level optimization problem in Equations 1a-b is solved (block 606) with respect to well, surface network, and facility equipment constraints (block 608), resulting in a candidate set of recommended lift gas flow rates lₙ for the wells, as well as the candidate well oil production rates qₙ(lₙ) (block 610). In optional steps (not shown) a surface network model with the identified candidate values may be run and a predicted well head flowing pressure for each well may be determined.

It should be noted that the candidate values identified in block 606 may not be optimized rates. This is because of the network back-pressure interference effects referenced earlier. When the candidate well oil production rates (e.g., the three-phase flow rates) are used as boundary conditions in the surface network model illustrated in FIG. 5, the computed well head flowing pressures may be different than the measured P_{wf} for each well. In this case, the lift performance of the well is dictated by a well lift performance curve that is different from the one assumed, so the process may need to be repeated, that is, should the measured P_{wf} have changed (“Yes” branch of decision block 612), the process returns to block 604. However, should the measured P_{wf} not have changed (“No” branch of decision block 612) the process returns to block 612. As time continues and new measurements of wellhead flowing pressure P_{wf} are made, the gas lift optimization process in FIG. 6 may be solved repeatedly, so that the optimum gas lift rates are re-determined as the underlying system and operating conditions change or in response to some other predetermined condition, such as the elapse of time or expiration of a timer.

### Distributed Gas Lift Monitoring and Control

In some embodiments, the field-level optimization process includes the following steps:

(1) Measurement sensors at each well sense the current conditions, notably wellhead flowing pressure P_{wf}, and these data are transmitted to a central processor, the location of which is arbitrary but is typically either a field or office setting or both. The method to transmit the data from the well location to the central location is arbitrary, and may include wired or wireless methods such as radios, satellite, cell phone, wireless computer network, copper cable or fiber optics. Often, a Supervisory Control and Data Acquisition (SCADA) system is used to perform this task.

(2) The optimization process in FIG. 6 is carried out in the central location to identify the set of N optimized well gas lift rates:

lₙ*n=1, 2, . . . , N (Eq 2)

(3) The optimized gas lift rates are transmitted back to the well location, often using the same SCADA and telemetry system as was used for the measurements. At each remote well location, an appropriate control system sets and maintains the lift gas flow rate at the desired value.

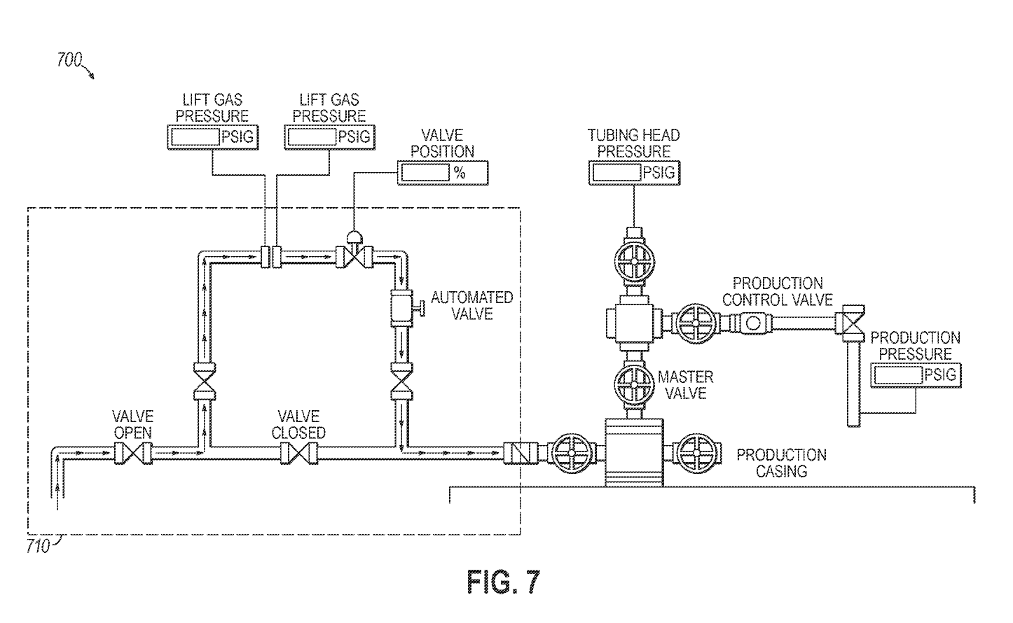

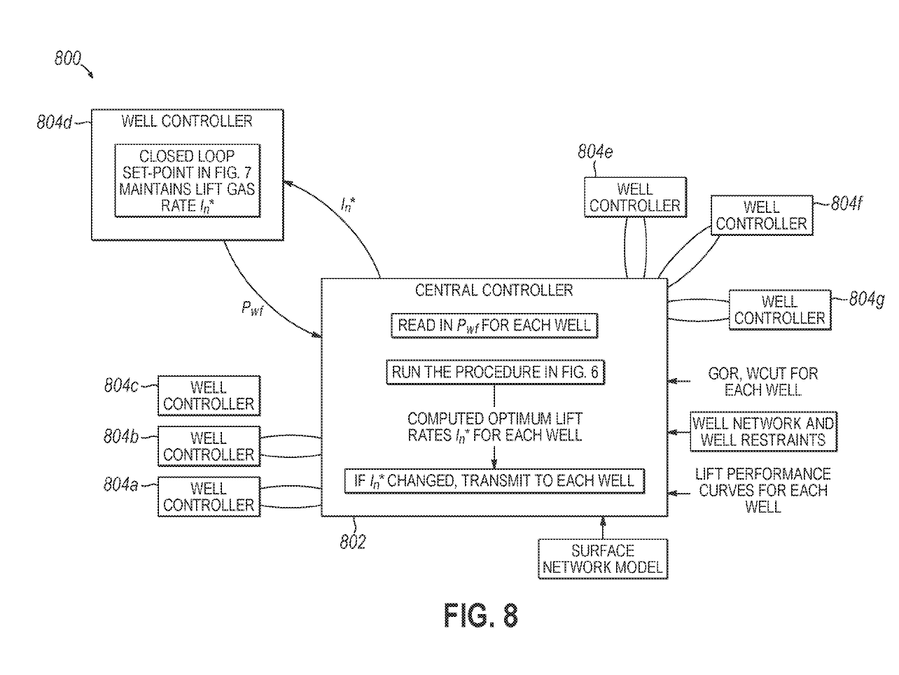

Individual wells may also be equipped with a Distributed Control System (DCS), such as the one illustrated by the section 710 (marked by the dashed lines) of the lift gas flow control line 700 of FIG. 7. For control of the lift gas rate at each well, a measurement is made of the lift gas temperature, pressure and pressure drop across an orifice, ΔP, which may be used in an AGA industry-standard computation to determine the rate of lift gas flow for the well. Via an electrical actuator or a motorized automated choke or valve, the system may continuously regulate the gas lift flow rate to maintain the rate at the desired well rate set points given in Equation 2 (this may be referred to as closed-loop set point control technology).

FIG. 8 illustrates a system 800 that performs field-wide lift optimization using an embodiment of available methods. A Central Controller 802 may have access to all of the individual well gas lift performance curves, as well as the surface network mathematical simulator model. The Central Controller 802 may also have knowledge of all of the relevant well, network and facility level constraints. The Central Controller 802 in some embodiments runs a large coupled simulation model (wells plus surface network) to determine the optimized set of gas lift flow rates that maximize production while satisfying the various constraints on the system 800. These optimized gas lift flow rates are transmitted to well controllers 804a-g for each respective well and are used by the respective well controllers 804a-g with a closed-loop set point controller to set and maintain the gas lift rate for each respective well at its optimized value. In one embodiment, as time advances and the system changes (e.g., P, at each well) the process repeats to maintain an optimized condition for the system 800. As such, an approach consistent with embodiments of the invention to optimize the field-wide distribution of available lift gas may be used to manage the performance of large oil fields.

### Field Optimization Using Distributed Intelligence and Single-Variable Slope Control

As mentioned above, one optimization approach may use centralized modeling of the well behavior and may depend on the computation of a mathematical model for the surface network in order to estimate the pressure interactions among the wells in the network. This can present certain operational challenges:
1) The mathematical network model is an approximation to reality, so the computed optimized lift gas rates are an approximation to the true optimum rates;
2) The mathematical network model may need to be continually re-calibrated so that it remains an accurate representation of the real network. In one embodiment, online measurements of the surface network (e.g., actual measurements of pressures, temperatures and flow rates) are cross-checked against the model calculations to insure that the two are consistent. If they differ substantially, a human operator may intervene to alter the surface network mathematical model to improve the match;
3) In one embodiment, the mathematical network model must be re-run whenever the surface network conditions change, that is, whenever the well head flowing back pressures P_{wf} change, so that the optimized lift gas rate values change. Surface network conditions can change frequently, for example, in response to instantaneous changes in the surface facility settings, equipment status and availability (equipment turning on and off), changes in ambient temperature, and at slower time scales, changes in fluid composition such as gas-oil ratio and water cut and surface network solid buildup or bottle-necking.

The present disclosure proposes methods for solving the field-wide gas lift optimization problem with an approach that includes system constraints and surface network pressure interference effects, but may do so without the need to compute a mathematical surface network model. This means that as the surface network changes day to day due to changes in temperature, equipment connections, plumbing changes, etc., there is typically no need to alter or calibrate a mathematical model for the surface network. Further, some embodiments consistent with the invention include a method that solves the N-well problem using decentralized or distributed computation, where each of the N wells solves a portion of the overall problem. This allows ever cheaper and more powerful computers to be placed at each well in order to effectively optimize the field-wide constrained resource allocation problem using decentralized parallel processing.

What follows is a description of a system that solves the optimization problem in Equations 1a-b, that is, it maximizes the field oil production rate subject to a constraint on available lift gas. As is the case with conventional centralized optimization procedures using a mathematical network model, the method disclosed herein can be extended to handle additional constraints at the well level (e.g. maximum drawdown or minimum well flowing pressure to avoid dropping below bubble point or causing other undesirable production or reservoir problems, limits on maximum wellhead temperature, etc.) and at the field level (e.g., maximum water or gas production rate that can be handled by the surface facilities). However, to simplify the discussion, the following description begins by considering only a single field-level constraint on available lift gas.

### Matched Performance Curve Slopes at Optimum Conditions

A known feature of the solution to the optimization problem in Equations 1a-b is that over the set of wells that are flowing lift gas, the optimized set of well lift rates obtained in Equation 2 all have the same value of performance curve slope S, i.e.,

$$S = {S}_{n} = \frac{\partial {q}_{n} ( {l}_{n}^{*} )}{\partial {l}_{n}} \\ n = 1 , 2 , … , N \qquad ( Eq 3 )$$

If this were not the case, and two or more wells had different values of curve slope, it would be possible to re-assign lift gas from one well (having smaller slope) to another well (having larger slope) and increase the field-wide oil production using the same amount of lift gas.

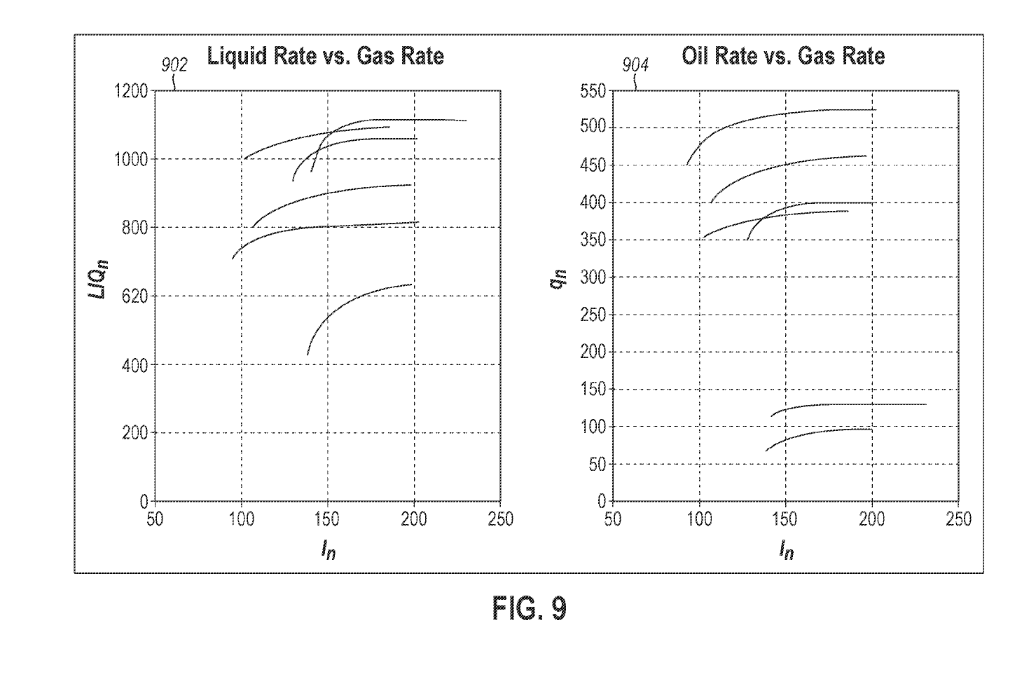

FIG. 9 illustrates the well lift performance curves for six wells producing into a common surface facility, with known measured well head flowing pressures. In particular, the left panel 902 indicates well liquid rate versus lift gas rate for each well. The right panel 904, however, indicates oil rate qₙ versus the lift gas rate lₙ for each well n=1, . . . , 6. Note that liquid rates range from 400 to 1100 stb/d, whereas oil rates range from 50 to 520 stb/d; two of the wells have markedly lower oil cuts than the other four wells.

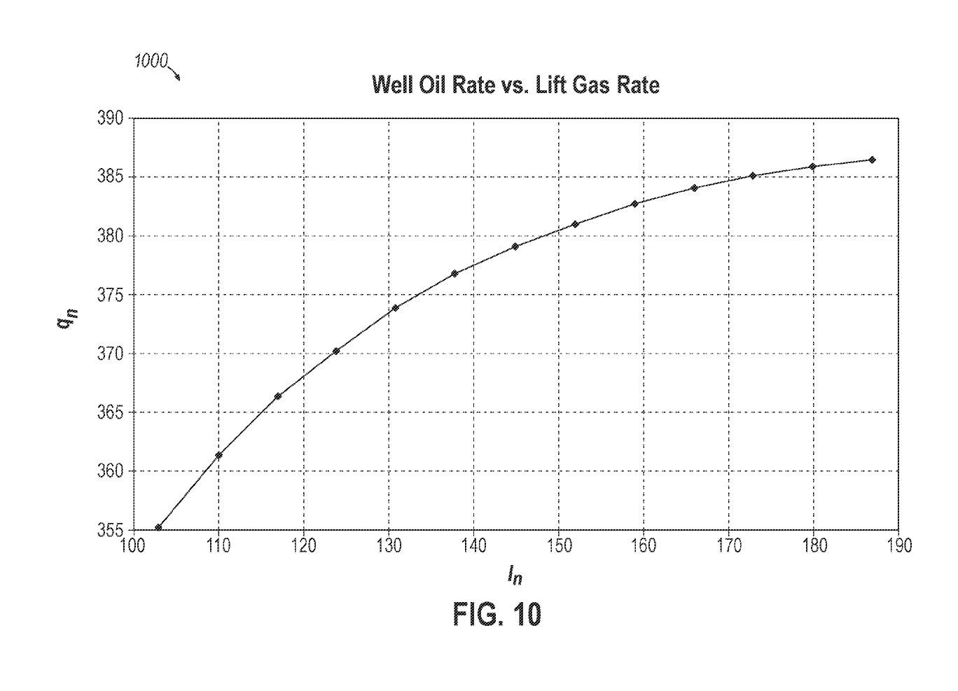

The fourth curve from the top in the right panel of FIG. 9 is re-plotted in FIG. 10 (oil rate between 355 and 387 stb/d; this well is referred to as “well 4”) as at 1000. By numerically differentiating this curve, the performance curve slope S is determined at every point along the curve.

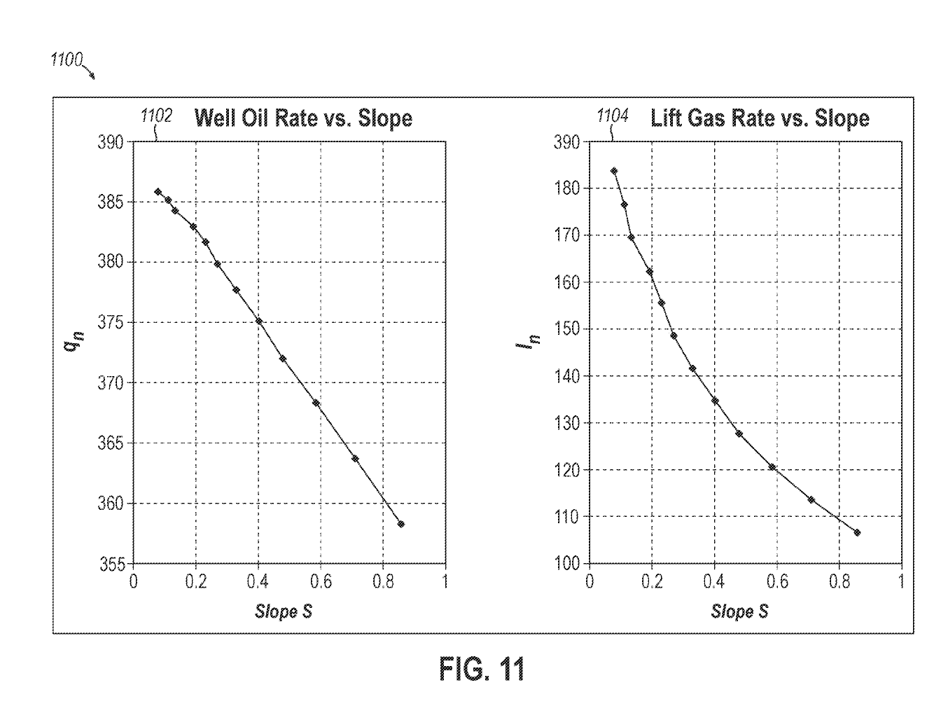

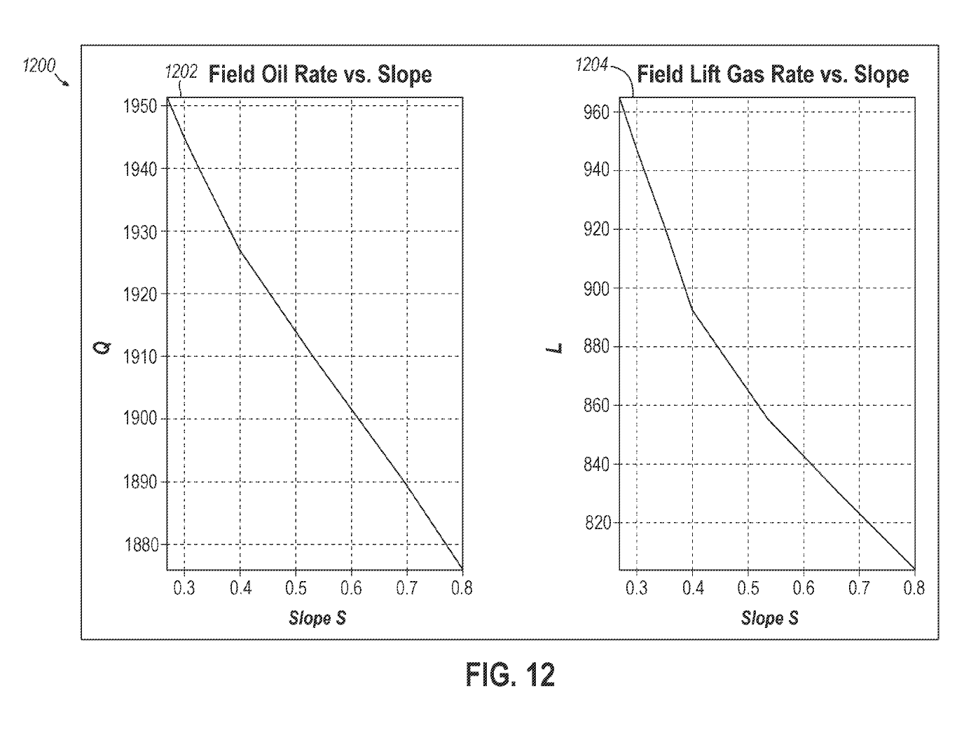

FIG. 11 illustrates the oil rate qₙ as at 1102 and the lift gas rate lₙ as at 1104 versus estimated slope S for well 4 as at 1200, which may also be referred to herein as well-specific oil production rate vs. slope and lift gas rate vs. slope curves. FIG. 12 is the result of summing these two curve types (oil and lift gas versus slope) over all six wells as at 1200, which may also be referred to herein as oilfield-wide oil production rate vs. slope and lift gas rate vs. slope curves.

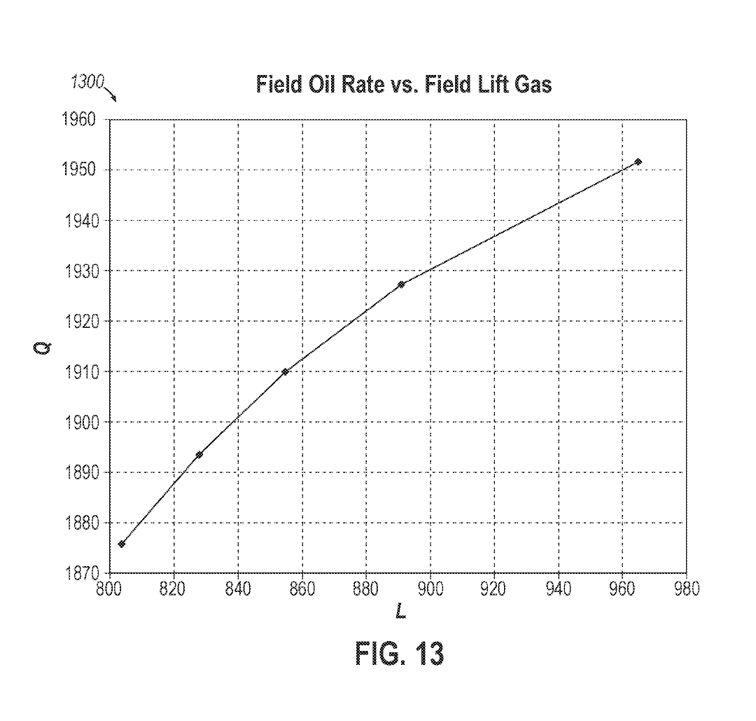

FIG. 13 is a cross-plot of the data in the two panels of FIG. 12, that is, the optimized field-wide oil production rate Q versus field-wide lift gas rate L, as at 1300. It should be noted that this curve cannot be obtained by simply summing well performance curves. Data from different well performance curves can only be combined if they correspond to the same optimization solution, i.e. they have the same performance curve slope S.

Once this set of figures is available, and knowing the well head flowing pressure P_{wf} at each well, the field-wide optimization solution may be determined directly. For example, suppose the total available lift gas is 900 mscf/d. The optimum field oil production rate Q from FIG. 13 is 1930 stb/d. From the right panel 1202 in FIG. 12, a total available lift gas of 900 mscf/d provides the optimum slope S*=0.38. From FIG. 11 for well 4, the optimum slope S*=0.38 corresponds to an optimum lift gas rate l*=137 mscf/d and an optimum oil rate q*=377 stb/d; this process can be repeated for each well to arrive at the six candidate optimum lift gas rates and well oil rates. These six candidate optimum lift gas rates and well oil rates are similar to rates output by block 606 of FIG. 6. These candidate well oil production rates may then be treated as rate boundary conditions in the computation of the mathematical surface network model; this model is computed to determine the six well head flowing pressures P_{wf}. These computed values may be compared to the original P_{wf} values, and if significantly different, new gas lift performance curves may be computed, and the procedure repeated until the P_{wf} values stop changing.

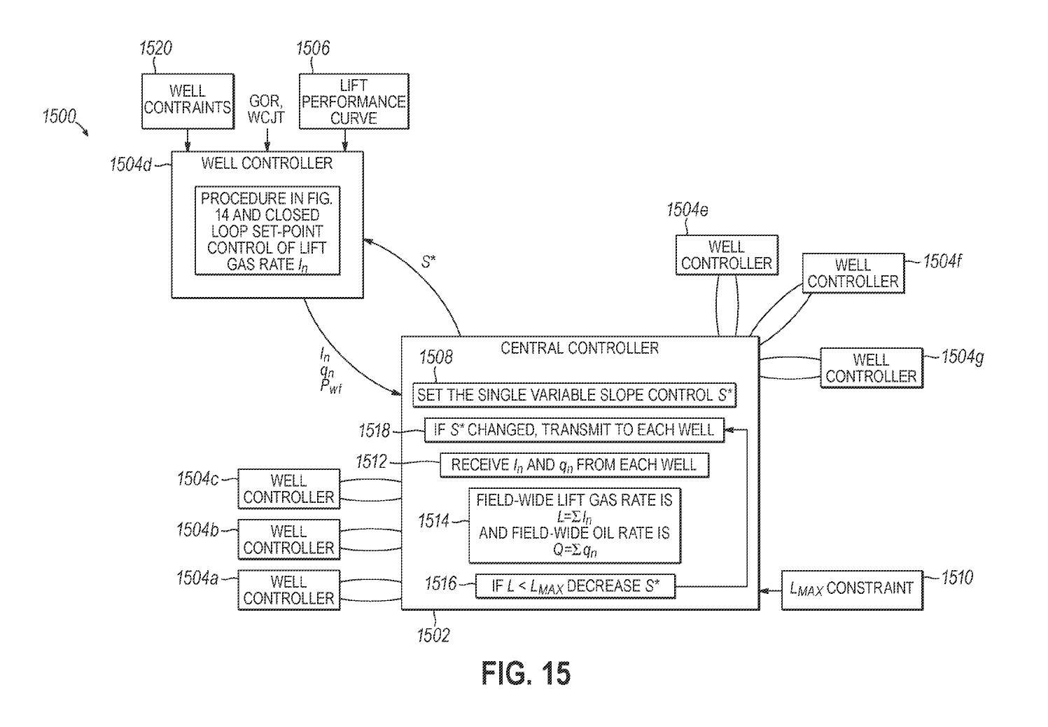

An exemplary method consistent with the invention, as at 1500 and as illustrated in FIG. 15, utilizes a central controller 1502 coupled to a plurality of remote wellhead lift gas controllers, also referred to herein as well controllers 1504a-f. The method includes:
1. Install on the well controller 1504a-f of each well the set of well lift performance curves (1506) for that well;
2. Use the common slope variable S as an oilfield-wide slope control variable between central controller 1502 and the well controller 1504a-f at each well;
3. Use the actual physical surface network (rather than running a centralized network software model) to determine the inter-well network pressure interactions;
4. Each well controller 1504a-f performs local closed-loop set-point control (see FIG. 14) to maintain the well gas lift performance at a point where the lift performance curve slope matches the control variable value; the well controller continues to maintain the slope at the set-point value as the well head flowing pressure P_{wf} varies due to possible network pressure interactions. As P_{wf} varies, a different well performance curve may be used, which in turn may require the lift gas rate to be altered slightly to maintain the set-point at the desired performance curve slope value.

FIG. 14 illustrates an exemplary optimization control process 1400 at each well. To begin, each of the well site controllers receives the same control signal S* (single variable slope control) transmitted from the central controller (block 1402). In block 1404, the well head controller measures the current well head flowing pressure P_{wf}, and uses it to interpolate the stored set of gas lift performance curves to obtain the current lift performance curve (q versus l) (block 1406). These curves are numerically differentiated to obtain the performance curve slope S at every point along the curve, and from this arrives at derivative performance curves l(S) and q(S) (block 1408). Alternatively, the derivative curves could be stored directly and interpolated. In block 1410, the desired lift gas rate is determined as l_{new}=l(S*), and in block 1412, the well lift gas controller is set to flow lift gas at rate l_{new}. The well head flowing pressure P_{wf} is monitored; it may vary due to the fact that all of the wells on the network are simultaneously adjusting their own lift gas flow rates, and the well pressures interact through the network. Because all of the wells in the field are adjusting their lift gas injection rates at the same time, to avoid the risk of system-wide instability, it may be necessary to introduce limits on how large a change each well controller can make at one time, or how quickly successive changes can be made by each well head controller. Once the well head flowing pressure P_{wf} stabilizes, the value is determined (block 1414) and then compared to the value of P_{wf} at the start of the cycle (block 1416). If they are significantly different, the procedure may be repeated until P_{wf} does not change significantly from one cycle to the next, by returning control to block 1406. Once the change is minimal, information is then transmitted from the well to the central controller (block 1418), including the stabilized values of lift gas flow rate lₙ, oil rate qₙ and well head flowing pressure P_{wf}.

FIG. 15 illustrates exemplary operation of the Central Controller 1502 and its interaction with each of the well site controllers 1504a-f. The Central Controller is responsible for selecting the appropriate value of the single-variable slope control S* for the entire field (block 1508) to maintain the total gas lift flow rate at or just below the available lift gas supply value of L_{MAX} (block 1510). As seen in FIG. 15, during every cycle, the Central Controller receives from each of the Well Controllers well production data, e.g., a lift parameter such as the lift gas being used (lₙ), a well production parameter such as the current produced oil rate (qₙ) and a well pressure parameter such as the current well head flowing pressure (P_{wf}) (block 1512). The field-wide lift gas usage L is obtained by summing the well lift gas rates lₙ, and the field-wide oil production rate Q is obtained by summing the well oil rates qₙ (block 1514). If L is below L_{MAX} (block 1516), there is spare unused lift gas capacity, so the Central Controller will decrease the single-variable slope control to a new value S* and transmit that to each well (block 1518). Once the summed value L is very close to the limiting value L_{MAX}, the field oil production has been optimized with respect to the constraint on available lift gas. The process is repeated to maintain the field system at an optimized condition.

FIG. 15 indicates that each Well Controller has available certain well-level constraint information (block 1520). This may include, for example, limits such as maximum well production rates (liquid, oil, water or gas), minimum bottom hole flowing pressure, maximum fluid velocity (erosion effects) and/or maximum well head temperature. When this information is available, the Well Controller process in FIG. 14 can be easily extended to handle these constraints. Specifically, at the step where the new lift gas flow rate lₛₑₜ is calculated (block 1410), an additional step maybe inserted to also compute the corresponding oil production rate q(lₛₑₜ). Knowledge of the oil rate and gas-oil ratio and water cut are sufficient to determine the liquid flow rate, as well as the water and gas flow rates. Additional thermal-hydraulic modeling information (e.g., by running a PIPESIM well model on the Central Controller and transmitted from time to time a set of response curves) may be stored at the Well Controller to allow the lift gas flow rate lₛₑₜ to be related to expected down hole flowing pressure, fluid velocity and well head temperature. Once the Well Controller is aware of these values, logic may be implemented locally on each Well Controller to determine the lift gas rate lₛₑₜ that respects all of the constraints at the well level; such as value may be smaller than the value determined with the process shown in FIG. 14 that accounts only for lift gas supply. When any well constraint actively limits the production from any well, that Well Controller may transmit this information to the Central Controller. At the level of the Central Controller, optimization would continue as earlier described in FIG. 15.

FIG. 15 indicates a set of information (S*, lₙ, qₙ, P_{wf}) that flows between the Central Controller and the Well Controller on a recurring basis, e.g., every few minutes. Less frequently, other information (not illustrated in FIG. 15) may be communicated, including:
1. Well level constraints such as maximum production rates (liquid, oil, water or gas), minimum bottom hole flowing pressure, and/or maximum well head temperature;
2. Produced fluid attributes such as gas-oil ratio and water cut;
3. The well gas lift performance curves (q versus l) for different values of P_{wf}.

This information typically varies much more slowly than lₙ, qₙ, P_{wf} and S*, and thus may be communicated between the Central and Well Controllers on a much less frequent basis, for example only from time to time when changes occur. During typical oilfield practice, a well is placed on production well testing to measure the individual oil, water and gas flow rates for the well; this may be done every 10 to 30 days per well. The data from the well test can be used to verify the quality of the information stored at the Well Controller, such as the water cut and gas-oil ratio. Also, the well test oil rate may be compared to the oil rate qₙ recently reported by the Well Controller. If they differ substantially, this may indicate inconsistency in the well model stored on the Well Controller, specifically the well gas lift performance curves. In this case, the Central Controller may be instructed to compute a new set of gas lift performance curves (possibly with human intervention) that are transmitted back to the Well Controller.

FIG. 15 indicates that the Central Controller receives the value of the limit on maximum available lift gas L_{MAX} (block 1510). Potentially, other network and facility constraints may be included, for example:
The maximum production water rate that can be handled by the surface facilities
The maximum production gas rate that can be handled by the surface facilities
The maximum production rate of other constituents such as H₂S rate, hydrates or condensates.

The herein-described embodiments may be extended to handle these additional constraints, since each Well Controller transmits to the Central Controller the individual well oil production rate qₙ, and the Central Controller has knowledge of the gas-oil ratio and water cut for each well, so the production liquid rate, water rate and gas rate may be determined for each well and summed. Similarly, if information is provided about the H₂S, hydrate and condensate levels in each well, flow rates may be similarly determined at the field level for these quantities. Knowledge of any or all of these quantities at the field level may provide a basis for the Central Controller to take them into account in optimizing the overall field performance. In some embodiments, optimizing field performance in the presence of field-level constraints may require wells to be shut-in (closed), as discussed in greater detail below.

### Shutting-In Low Performance Wells to Optimize Field Performance

As described in earlier sections, single-variable slope control may be used to achieve a condition where all of the actively flowing wells in a field are flowing under conditions that optimize overall field performance. Namely, each flowing well n=1, . . . , N is operating at the same value of gas lift performance slope S*=Sₙ=∂qₙ/∂lₙ which expresses the marginal rate of return for each well (incremental oil produced per additional unit of incremental lift gas). The optimization algorithm matches the marginal performance of every well that is flowing, but does not consider the benefit of shutting in certain wells that have poor absolute performance (well oil production rate divided by well lift gas rate). At optimized conditions, the absolute performance qₙ/lₙ across the many wells in the field may vary widely. For example, a very high water cut well will typically require a large amount of lift gas to lift the well's production which is mostly water; this well returns a small oil rate and thus has a small value of qₙ/lₙ, even though the marginal return expressed as the performance slope Sₙ=S* is the same as every other flowing well when the field is optimized as described earlier.

Consider the field-level problem of optimizing field oil rate, constrained by the total available lift gas L_{MAX}. Once the single-variable slope control algorithm has optimized the set of flowing wells, consider the j^{th} well as a candidate for shut-in to improve field performance. At the N-well optimum point, the lift gas rate into well j is lⱼ*. By shutting in well j, the amount of gas lⱼ* maybe re-assigned to the N−1 remaining flowing wells, where the optimized rates over the N−1 wells are determined using single-variable slope control optimization. The question to be addressed is whether or not the optimized N−1 well configuration provides more net oil compared to the original N well configuration.

In both cases, the total lift gas will be at the available gas L_{MAX}, so equating the two scenarios:

$${L}_{MAX} = {\sum }_{n = 1}^{N} {l}_{n} ( {S}^{*} , p ) = {\sum }_{n \neq j} {l}_{n} ( {S}_{j} , {p}^{′} ) \qquad ( Eq 4 )$$

The first sum over N terms is the total lift gas for the N-well problem expressed as the sum of the individual well lift rates at optimized slope value S*; the variable p denotes the N-vector of flowing well head pressure values across the N wells in the network. The second sum is over the N−1 active wells when well j has been shut in and the system re-optimized to operate at a new optimized slope value Sⱼ, with a corresponding (N−1)-vector of well head flowing pressures p′. Each term in the second sum may be expressed as a truncated Taylor series expansion around the N-well optimum condition, were the series expansion is terminated after the linear terms, providing:

$${\sum }_{n = 1}^{N} {l}_{n} ( {S}^{*} , p ) = {\sum }_{n \neq j} \{ {l}_{n} ( {S}^{*} , p ) + \frac{\partial {l}_{n}}{\partial S} Δ {S}_{j} + \frac{\partial {l}_{n}}{\partial {p}_{n}} Δ {p}_{nj} \} \qquad ( Eq 5 )$$

The middle term in the right-hand side corresponds to the perturbation in the lift gas rates due to the change in the field-wide slope control by ΔSⱼ=Sⱼ−S* when well j is shut-in. The last term corresponds to the perturbation in the lift gas rates due to the change in the n^{th} well P_{wf} due to well j being shut-in and its lift gas being optimally redistributed to the remaining N−1 wells across the field. Note that when this equation is simplified, all of the terms on the left-hand side disappear except the j^{th}:

$${l}_{j} ( {S}^{*} , p ) = Δ {S}_{j} [ {\sum }_{n \neq j} \frac{\partial {l}_{n}}{\partial S} ] + {\sum }_{n \neq j} \frac{\partial {l}_{n}}{\partial {p}_{n}} Δ {p}_{nj} \qquad ( Eq 6 )$$

This equation shows that the lift gas currently applied to well j could, upon shut-in of well j, be re-distributed to the remaining N−1 wells with two effects:
1. The last term may be interpreted as the result of removing the j^{th} well liquid rate, which unloads the network, decreasing the flowing well head pressures at all the wells, causing them to move to higher-rate lift performance curves. Even if the N−1 lift gas rates remained unchanged, the oil production from these wells would go up as a result of the decreased well head flowing pressure (but perhaps not enough to replace the oil lost by closing well j). By also allowing the lift gas from well j to be redistributed across the N−1 wells using single-variable slope control, the lift rates in the N−1 wells will generally increase, production rates will increase, the network pressure will rise and P_{wf} values will increase. After all of these effects have occurred and stabilized, the net change in well head pressure in well n is reflected in the term Δpₙⱼ. In the case where lift gas redistribution results in the network re-pressurizing to roughly the same well head pressures as the base case, Δpₙⱼ may have small magnitude.
2. The first term on the right-hand side of Equation 6 may be interpreted as the result of taking the newly available lift gas from well j, and (assuming that the P_{wf} values all remained constant) redistributing it by changing the value of the single variable slope control by an amount ΔSⱼ=Sⱼ−S* over the remaining N−1 wells, leading to increased field oil production.

Of interest is the degree to which the field oil rate changes by shutting in well j. Let ΔQⱼ denote the difference between the (N−1)-well field oil rate (with well j shut-in) and the original N-well field oil rate; a positive value of ΔQⱼ indicates that it would be better to shut-in well j and redistribute the gas to the remaining wells. If ΔQⱼ is zero or negative, this indicates that there is no benefit to shutting in well j. The following expression describes ΔQⱼ:

$$Δ {Q}_{j} = {Q}_{( well j shut - i n )} - {Q}_{( N wells flowing )} = {\sum }_{n \neq j} {q}_{n} ( {S}_{j} , {p}^{′} ) - {\sum }_{1}^{N} {q}_{n} ( {S}^{*} , p ) \qquad ( Eq 7 )$$

As earlier in Equation 4, the optimized slope variables take on values S* and Sⱼ for the two cases, and the distribution of well head flowing pressures are p and p′. Following a similar approach to the lift gas expressions, the oil rate in the (N−1)-well case can be expressed as a linear perturbation about the values in the N-well problem:

$$Δ {Q}_{j} = {\sum }_{n \neq j} [ {q}_{n} ( {S}^{*} , p ) + \frac{\partial {q}_{n}}{\partial S} Δ {S}_{j} + \frac{\partial {q}_{n}}{\partial {p}_{n}} Δ {p}_{nj} ] - {\sum }_{n = 1}^{N} {q}_{n} ( {S}^{*} , p ) \qquad ( Eq 8 )$$

Simplifying, all of the terms in the last sum disappear except the j^{th}, leading to:

$$Δ {Q}_{j} = Δ {S}_{j} [ {\sum }_{n \neq j} \frac{\partial {q}_{n}}{\partial S} ] + {\sum }_{n \neq j} \frac{\partial {q}_{n}}{\partial {p}_{n}} Δ {p}_{nj} - {q}_{j} ( {S}^{*} , p ) \qquad ( Eq 9 )$$

Equations 4 through 9 consider the effect of shutting-in well j and re-distributing the newly available gas lⱼ* to arrive at a new field-wide optimized distribution of lift gas, including the effects of changing performance slope S and changing well head pressures pₙ. In the event that the well head pressures after re-distribution of newly available gas are similar in value to the original well head pressures, the Δpₙⱼ quantities in Equations 6 and 9 are small. In what follows, these terms are assumed to be negligible, in which case Equation 6 can be solved for ΔSⱼ:

$$Δ {S}_{j} = \frac{{l}_{j} ( {S}^{*} , p )}{{\sum }_{n \neq j} \frac{\partial {l}_{n}}{\partial S}} \qquad ( Eq 10 )$$

This result can be substituted into Equation 9 to provide:

$$Δ {Q}_{j} = [ \frac{{\sum }_{n \neq j} \frac{\partial {q}_{n}}{\partial S}}{{\sum }_{n \neq j} \frac{\partial {l}_{n}}{\partial S}} ] {l}_{j}^{*} - {q}_{j}^{*}$$

Equation 11 provides an approximate method to assess the potential improvement in field-wide oil production by considering the shut-in of the j^{th} well, followed by re-optimization. Specifically, after N wells have been optimized and the limit on available lift gas has been reached, the quantity in Equation 11 is calculated for every well in the field, and the results ordered; the wells with the largest values of ΔQ_{P} are the best candidates to consider for shut-in. This makes sense intuitively—the quantity in brackets is the ratio of two negative numbers and thus it is positive; wells consuming large amounts of lift gas lⱼ* and returning small oil rate qⱼ* have large positive values of ΔQⱼ and are thus good candidates for shut-in.

In the event that any well is actively limited by a local well-level constraint, that well may still be included in the computations in Equations 4 through 11, using the current (limited) values of lift gas lⱼ* and oil rate qⱼ* and noting that the partial derivatives ∂lₙ/dS and ∂qₙ/dS are zero, since a change in slope S by the Central Controller does not alter the lift gas rate or oil production rate in a locally constrained well. Local well-level constraints may include, for example, limits on drawdown pressure due to bubble point or sanding considerations, or limits on maximum well head temperature or velocity due to pipe erosion considerations.

The method described in Equations 4 through 11 predicts the result of shutting in a well, beginning with N wells, shutting one in, and optimally re-distributing the newly available gas to the remaining (N−1) wells. Once one or more wells are shut-in this way, there may be a “pool” of shut-in wells that may also be considered as candidates to turn back on. The same process as that in equations 4 through 11 may be used to consider adding a well, beginning with N wells, turning on one additional well, and optimally re-distributing lift gas to the (N+1) wells (the lift gas needed by the newly added well is optimally “taken-away” from the original N wells). Deriving this case leads to the same Equations 4 through 11, and in particular the incremental oil in Equation 11 can also be computed for the currently shut-in wells and rank-ordered along with all of the active wells to assess whether shutting in an active well or re-activating a shut-in well is the better action.

In terms of distributed computation, the individual elements in the two partial derivative sums in Equation 11 may be calculated by each decentralized Well Controller by adding an additional step to the process illustrated in FIG. 14. The two derivatives for a well may then be communicated back to the Centralized Controller by adding communicated variables in FIG. 15. The Centralized Controller may then combine the derivatives from all of the wells using Equation 11 and select which wells to shut in. Overall, the field-level procedure is: (1) optimize the original N wells using single-variable slope variable optimization, (2) compute ΔQⱼ in Equation 11 for all N active wells [and shut-in wells if any]; (3) if the largest such value is significantly greater than zero, shut in [or turn on] that well and (4) re-optimize the N−1 [or N+1] remaining wells using single-variable slope variable optimization, and repeat this process by returning to step 2 until the largest value of ΔQⱼ no longer significantly exceeds zero.

The exemplary method described thus far assumes that the production system being optimized is characterized by only a single field-level constraint, namely a limit L_{MAX} on the available lift gas rate in the field. In practice, many other types of constraints may arise. For example, surface facility separators and treating equipment may not be able to handle large rates of produced water, gas, H₂S, condensate, and other production constituents, any or all of which may lead to maximum limits. The method described in the previous section maybe generalized to handle a variety of field-level production constraints.

Consider the case of a field where one or more of the quantities just mentioned are constrained with upper limits, for example, field produced water rate is limited by W_{MAX} or field produced gas rate is limited by G_{MAX}. To begin, suppose the single-variable slope control S* in FIG. 15 is gradually being decreased to gradually increase the N well lift gas rates and production rates, and that none of the field level constraints has yet become active. At some point, suppose one of the field-level constraints becomes active, and for generality it is not the available lift gas limit L_{MAX} which was addressed in the previous section. Instead, suppose it is one of the other variables like produced water reaching the limit W_{MAX} or produced gas reaching the limit G_{MAX}. To solve the more general problem, let the variable u denote the variable whose constraint has just become active at upper limit U_{MAX}.

In a parallel to Equations 4 through 9, at the moment the u-constraint becomes active, the N wells are producing a total of U_{MAX} of the variable u field-wide. Now, consider shutting in well j and reallocating the available lift gas lⱼ* and re-optimizing the remaining N−1 wells until the u-constraint becomes active again (upon re-optimization with N−1 wells, a constraint other than the u-constraint may become active, but the u-constraint is assumed to still be the active constraint for purposes of identifying shut-in candidates). Equating the field-wide U values under these two scenarios:

$${U}_{MAX} = {\sum }_{n = 1}^{N} {u}_{n} ( {S}^{*} , p ) = {\sum }_{n \neq j} {u}_{n} ( {S}_{j} , {p}^{′} ) \qquad ( Eq 12 )$$

The first sum corresponds to the N-well problem optimized at single-variable slope parameter value S* and well head pressures p. The second sum corresponds to the (N−1)-well problem optimized at the single-variable slope parameter value Sⱼ and collection of N−1 well head pressures p′. Following the same steps as in Equations 4 through 11:

$${\sum }_{n = 1}^{N} {u}_{n} ( {S}^{*} , p ) = {\sum }_{n \neq j} \{ {u}_{n} ( {S}^{*} , p ) + \frac{\partial {u}_{n}}{\partial S} Δ {S}_{j} + \frac{\partial {u}_{n}}{\partial {p}_{n}} Δ {p}_{n j} \} \qquad ( Eq 13 )$$

and simplifying:

$${u}_{j} ( {S}^{*} , p ) = Δ {S}_{j} [ {\sum }_{n \neq j} \frac{\partial {u}_{n}}{\partial S} ] + {\sum }_{n \neq j} \frac{\partial {u}_{n}}{\partial {p}_{n}} Δ {p}_{nj} \qquad ( Eq 14 )$$

Assuming the Δp terms are negligible and solving for ΔSⱼ:

$$Δ {S}_{j} = \frac{{u}_{j} ( {S}^{*} , p )}{{\sum }_{n \neq j} \frac{\partial {u}_{n}}{\partial S}} \qquad ( Eq 15 )$$

The change in field oil rate by shutting in the j^{th} well is given by Equations 7 through 9. Substituting Equation 15 into Equation 9 and assuming the Δp terms are negligible:

$$Δ {Q}_{j} = [ \frac{{\sum }_{n \neq j} \frac{\partial {q}_{n}}{\partial S}}{{\sum }_{n \neq j} \frac{\partial {u}_{n}}{\partial S}} ] {u}_{j}^{*} - {q}_{j}^{*} \qquad ( Eq 16 )$$

Equation 16 provides a basis to assess the effect of shutting in well j when the field level constraint on variable u has become active. Shutting in well j frees up quantity uⱼ* of variable u produced by well j and entering the network. This allows the slope control variable S to be decreased in order to push the remaining N−1 wells to produce larger amounts of variable u (until the field-wide total reaches U_{MAX}) as well as additional oil (until the field-wide oil rate achieves an incremental production level of ΔQⱼ).

For example, if the u-constraint is a water handling limit, Equation 16 ranks shut-in candidates based on the well water rate uⱼ* versus the well oil rate qⱼ*. While the criterion in Equation 16 is not exactly water-oil ratio (it is a comparison of weighted water rate to oil rate), wells that have high WOR will also have high values of ΔQⱼ and thus will be good candidates to shut-in when the field-wide water handling constraint is met. Likewise, if the u-constraint is a gas handling limit, Equation 16 ranks shut-in candidates based on the well gas rate uⱼ* versus the well oil rate qⱼ*. While the criterion in Equation 16 is not exactly gas-oil ratio (it is a comparison of weighted gas rate to oil rate), wells that have high GOR (including both the produced gas and the cycled lift gas) will also have high values of ΔQⱼ and thus will be good candidates to shut-in when the field-wide gas handling constraint is met.

In many oil fields, more than one type of lift system is used. For example, a mix of gas-lift (GL) and centrifugal pumps such as electro-submersible pumps (ESPs) or progressing cavity pumps (PCPs) may be used. As described earlier, the GL field-level problem is to maximize the overall field oil rate by optimally allocating a fixed available supply of lift gas to N gas-lifted wells; gas allocation is controlled at the well level via a lift gas adjustable choke. For centrifugal pumps, the field-level problem is to maximize the overall field oil rate by optimally allocating a fixed supply of electrical power to N pump-lifted wells; electricity allocation is controlled at the well level via a motor speed controller (variable speed drive) or pump-off controller that periodically stops the pump (fixed speed drive).

The methods described herein may be extended to cover mixed lift types by identifying a common independent variable, such as a monetary unit like dollars. Each lift resource has a cost. For example, lift gas must be compressed and has associated compressor horsepower and fuel costs that can be expressed as dollars per unit lift gas; electricity must be generated or purchased at a cost expressed as dollars per KwHr of electricity. By expressing each lift type performance curve (such as those illustrated in FIG. 4 for GL) as output oil rate versus input cost in dollars, the approach described earlier applies across all lift types simultaneously, although each lift type may have its own upper limit. In this case, the performance curve slope S in Equation 3 may be re-expressed across all the lift types as:

$$S = {S}_{n} = \frac{\partial {q}_{n} ( {l}_{n}^{*} )}{\partial {d}_{n}} \\ n = 1 , 2 , … , N \qquad ( Eq 17 )$$

where qₙ is the oil rate (stb/d) from well n and dₙ is the dollar spend rate ($/d) on lift resource for well n.

### Interpretation of Sₙ in Terms of Spot Price

In Equation 17 the slope control variable S has units of oil volume per dollar (stb/$). The inverse of Sₙ, (denoted Tₙ=1/Sₙ), has units of dollars per unit oil ($/stb) and can be thought of as the instantaneous marginal price the Central Controller is willing to pay to purchase additional oil from the N distributed sales points (active production wells). This has some parallels to commodity trading, where Tₙ is the oil “spot price” and is a meaningful single variable of communication between the central controller and the individual well controllers. At the level of each distributed sales point or well, Tₙ represents the ease with which the well can deliver additional oil for an incremental increase in lit resource, and this is not constant but depends on the present operating point.

### Computer System for Oilfield Application System

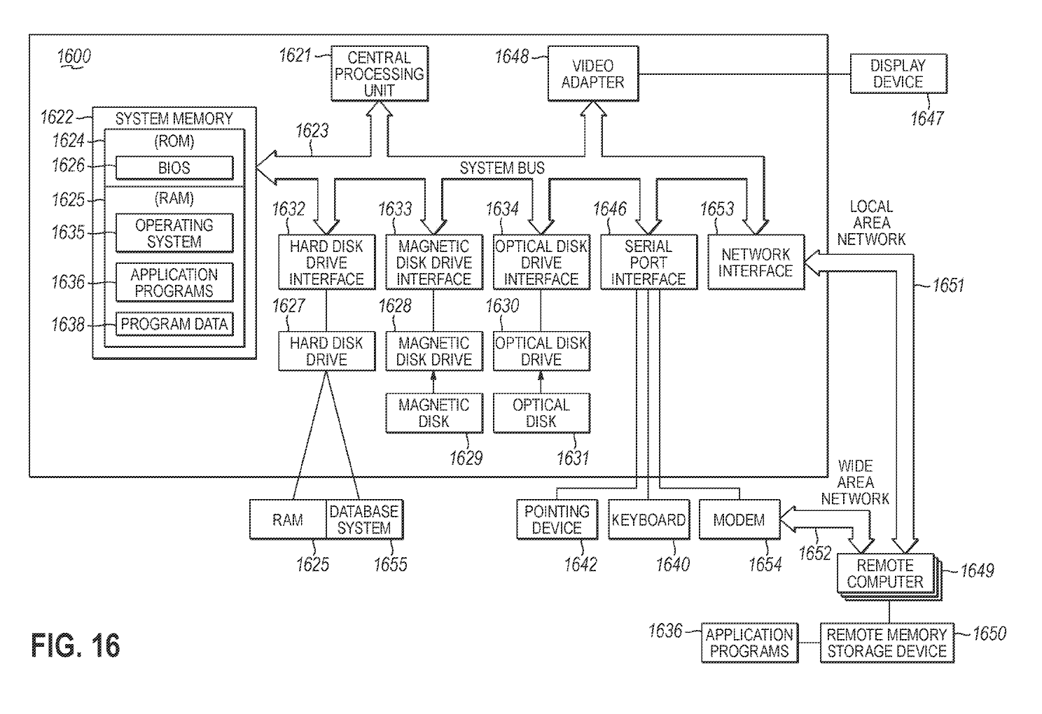

FIG. 16 illustrates a computer system 1600 into which implementations of various technologies and techniques described herein may be implemented. In one implementation, computing system 1600 may be a conventional desktop or a server computer, but it should be noted that other computer system configurations may be used.

The computing system 1600 may include a central processing unit (CPU) 1621, a system memory 1622 and a system bus 1623 that couples various system components including the system memory 1622 to the CPU 1621. Although only one CPU is illustrated in FIG. 16, it should be understood that in some implementations the computing system 1600 may include more than one CPU. The system bus 1623 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 1622 may include a read only memory (ROM) 1624 and a random access memory (RAM) 1625. A basic input/output system (BIOS) 1626, containing the basic routines that help transfer information between elements within the computing system 1600, such as during start-up, may be stored in the ROM 1624.

The computing system 1600 may further include a hard disk drive 1627 for reading from and writing to a hard disk, a magnetic disk drive 1628 for reading from and writing to a removable magnetic disk 1629, and an optical disk drive 1630 for reading from and writing to a removable optical disk 1631, such as a CD ROM or other optical media. The hard disk drive 1627, the magnetic disk drive 1628, and the optical disk drive 1630 may be connected to the system bus 1623 by a hard disk drive interface 1632, a magnetic disk drive interface 1633, and an optical drive interface 1634, respectively. The drives and their associated computer-readable media may provide nonvolatile storage of computer-readable instructions, data structures, program modules and other data for the computing system 1600.

Although the computing system 1600 is described herein as having a hard disk, a removable magnetic disk 1629 and a removable optical disk 1631, it should be appreciated by those skilled in the art that the computing system 1600 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 1600. Communication media may embody computer readable instructions, data structures, program modules or other data in a modulated data signal, such as a carrier wave or other transport mechanism and may include any information delivery media. By way of example, and not limitation, communication media may include wired media such as a wired network or direct-wired connection, and wireless media such as acoustic, RF, infrared and other wireless media. Combinations of any of the above may also be included within the scope of computer readable media.

A number of program modules may be stored on the hard disk 1627, magnetic disk 1629, optical disk 1631, ROM 1624 or RAM 1625, including an operating system 1635, one or more application programs 1636, program data 1638 and a database system 1655. The operating system 1635 may be any suitable operating system that may control the operation of a networked personal or server computer, such as Windows® XP, Mac OS® X, Unix-variants (e.g., Linux® and BSD®), and the like. In one implementation, program code suitable for implementing the functionality disclosed in FIGS. 14-15, for example, may be implemented as application programs 1636 in FIG. 16.

A user may enter commands and information into the computing system 1600 through input devices such as a keyboard 1640 and pointing device 1642. Other input devices may include a microphone, joystick, game pad, satellite dish, scanner or the like. These and other input devices may be connected to the CPU 1621 through a serial port interface 1646 coupled to system bus 1623, but may be connected by other interfaces, such as a parallel port, game port or a universal serial bus (USB). A monitor 1647 or other type of display device may also be connected to system bus 1623 via an interface, such as a video adapter 1648. In addition to the monitor 1647, the computing system 1600 may further include other peripheral output devices such as speakers and printers.

Further, the computing system 1600 may operate in a networked environment using logical connections to one or more remote computers 1649. The logical connections may be any connection that is commonplace in offices, enterprise-wide computer networks, intranets, and the Internet, such as local area network (LAN) 1651 and a wide area network (WAN) 1652. The remote computers 1649 may each include application programs 1636 similar to that as described above.

When using a LAN networking environment, the computing system 1600 may be connected to the local network 1651 through a network interface or adapter 1653. When used in a WAN networking environment, the computing system 1600 may include a modem 1654, wireless router or other means for establishing communication over a wide area network 1652, such as the Internet. The modem 1654, which may be internal or external, may be connected to the system bus 1623 via the serial port interface 1646. In a networked environment, program modules depicted relative to the computing system 1600, or portions thereof, may be stored in a remote memory storage device 1650. It will be appreciated that the network connections shown are exemplary and other means of establishing a communications link between the computers may be used.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device and at least one output device. One or more programs that may implement or utilize the various technologies described herein may use an application programming interface (API), reusable controls and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

While the foregoing is directed to implementations of various technologies described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of performing field lift optimization, the method comprising:
causing at least one well among a plurality of wells in an oilfield to control a lift parameter associated with an artificial lift mechanism for the well in response to an oilfield-wide slope control variable, wherein the oilfield-wide slope control variable is usable to determine the lift parameter based upon at least one well-specific performance curve for the well.

2. The method of claim 1, wherein causing the well to control the lift parameter includes, in a first controller coupled to the plurality of wells, determining the oilfield-wide slope control variable by performing an oilfield-wide optimization and communicating the oilfield-wide slope control variable to a second controller coupled to the well.

3. The method of claim 2, wherein causing the well to control the lift parameter further includes, in the second controller, determining the lift parameter based upon the oilfield-wide slope control variable and the at least one well-specific performance curve for the well.

4. The method of claim 2, wherein the second controller is a well controller, the method further comprising, in the first controller, communicating the oilfield-wide slope control variable to well controllers for each of the plurality of wells, the method further comprising:
receiving well production data from each well controller;
updating the oilfield-wide slope control variable in response to the well production data; and
communicating the updated oilfield-wide slope control variable to each well controller to cause each well controller to update a well-specific lift parameter based upon the updated oilfield-wide slope control variable.

5. The method of claim 4, wherein the well production data includes a lift parameter, a well production parameter and a well pressure parameter.

6. The method of claim 2, further comprising constraining the oilfield-wide slope control variable based upon a field-level constraint.

7. The method of claim 2, wherein determining the oilfield-wide slope control variable includes:
determining a potential improvement in oilfield-wide oil production based upon the shut-in or turn on of at least one of the plurality of wells; and
based upon the determined potential improvement, determining the oilfield-wide slope control variable assuming that at least one of the plurality of wells is shut-in or turned on and communicating the oilfield-wide slope control variable to at least a subset of the plurality of wells.

8. The method of claim 1, further comprising, in a well controller coupled to the well, receiving the oilfield-wide slope control variable from a central controller and generating the lift parameter based upon the at least one well-specific performance curve for the well.

9. The method of claim 8, further comprising constraining the lift parameter based upon a well-level constraint.

10. The method of claim 8, further comprising, in the well controller, maintaining the artificial lift mechanism to match a lift performance curve slope for the well with the oilfield-wide slope control variable.

11. The method of claim 8, wherein generating the lift parameter includes:
determining a derivative lift performance curve based upon a current well head flowing pressure for the well, wherein the derivative lift performance curve maps the lift parameter to a slope of a lift performance curve for the current well head flowing pressure for the well; and
determining the lift parameter from the derivative lift performance curve.

12. The method of claim 11, wherein determining the derivative lift performance curve includes selecting the derivative lift performance from among a plurality of stored derivative lift performance curves in the well controller.

13. The method of claim 11, wherein determining the lift parameter includes determining the current lift performance curve from a plurality of lift performance curves accessible by the well controller based upon the current well head flowing pressure for the well, wherein each of the plurality of lift performance curves maps the lift parameter against a production parameter for a given well head flowing pressure.

14. The method of claim 1, wherein the artificial hit mechanism comprises a gas lift mechanism and wherein the lift parameter comprises a lift gas rate.

15. The method of claim 1, wherein the artificial lift mechanism comprises a gas lift mechanism, wherein the lift parameter comprises a lift gas rate, and wherein causing the well to control the lift parameter includes:
in a central controller, determining the oilfield-wide slope control variable by:
for each of the plurality of wells, determining a performance curve slope for a performance curve for a given well head flowing pressure for such well over a range of lift gas rates;
for each of the plurality of wells, mapping an oil production rate and a lift gas rate against the performance curve slope to generate well-specific oil production rate vs. slope and lift gas rate vs. slope curves;
summing the well-specific oil production rate vs. slope and lift gas rate vs. slope curves for the plurality of wells to generate oilfield-wide oil production rate vs. slope and lift gas rate vs. slope curves;
cross-plotting oilfield-wide oil production rate against oilfield-wide lift gas rate using the oilfield-wide oil production rate vs. slope and lift gas rate vs. slope curves to generate a cross-plot; and
determining the oilfield-wide slope control variable from the cross-plot, the oilfield-wide oil production rate vs. slope curve, the oilfield-wide lift gas rate vs. slope curve, the well-specific well oil production rate vs. slope curves and the well-specific lift gas rate vs. slope curves to optimize field-wide oil production rate based upon at least one field-level lift gas restraint;
in the central controller, communicating the oilfield-wide slope control variable to a plurality of well controllers, each associated with a well among the plurality of wells;
in each of the plurality of well controllers, receiving the oilfield-wide slope control variable and determining a well-specific lift gas rate for such associated well by:
interpolating a stored set of gas lift performance curves for such associated well based upon a well head flowing pressure for such associated well to determine a current lift performance curve;
numerically differentiating the current lift performance curve to determine a performance curve slope at a plurality of points on the current lift performance curve and thereby generate a derivative performance curve; and
determining the well-specific lift gas rate from the derivative performance curve based upon the oilfield-wide slope control variable;
in each of the plurality of well controllers, setting the gas lift mechanism based upon the well-specific lift gas rate, thereafter recalculating the well-specific lift gas rate in response to a change in the well head flowing pressure for such associated well, and communicating to the central controller the well-specific lift gas rate, an oil production rate and the well head flowing pressure for such associated well; and
in the central controller, recalculating the oilfield-wide slope control variable based upon the well-specific lift gas rate, oil production rate and well head flowing pressure communicated to the central controller by each of the plurality of well controllers.

16. A computing device, comprising:
at least one processor; and
program code configured upon execution by the at least one processor to perform field lift optimization by generating an oilfield-wide slope control variable for use in controlling, for each of a plurality of wells in an oilfield, an artificial lift mechanism for such well, and communicating the oilfield-wide slope control variable to each of the plurality of wells, wherein the oilfield-wide slope control variable is usable by each well to determine a lift parameter for the artificial lift mechanism for such well based upon at least one well-specific performance curve for such well.

17. The computing device of claim 16, wherein the program code is further configured to receive well production data from each well, update the oilfield-wide slope control variable in response to the well production data, and communicate the updated oilfield-wide slope control variable to each well to cause each well to update a well-specific lift parameter based upon the updated oilfield-wide slope control variable.

18. The computing device of claim 16, wherein the program code is further configured to constrain the oilfield-wide slope control variable based upon a field-level constraint.

19. The computing device of claim 16, wherein the program code is further configured to determine a potential improvement in field-wide oil production based upon the shut-in or turn on of at least one of the plurality of wells, based upon the determined potential improvement, determine an updated oilfield-wide slope control variable assuming that at least one of the plurality of wells is shut-in or turned on, and communicate the updated oilfield-wide slope control variable to at least a subset of the plurality of wells.

20. A computing device, comprising:
at least one processor; and
program code configured upon execution by the at least one processor to perform field lift optimization for a well among a plurality of wells in an oilfield by receiving an oilfield-wide slope control variable from a central controller and generating therefrom a lift parameter for an artificial lift mechanism for such well based upon at least one well-specific performance curve for such well.

21. The computing device of claim 20, wherein the program code is further configured to maintain the artificial lift mechanism to match a lift performance curve slope for the well with the oilfield-wide slope control variable, determine a derivative lift performance curve based upon a current well head flowing pressure for the well, wherein the derivative lift performance curve maps the lift parameter to a slope of a lift performance curve for the current well head flowing pressure for the well, and determine the lift parameter from the derivative lift performance curve.

22. The computing device of claim 20, wherein the artificial lift mechanism comprises a gas lift mechanism, wherein the lift parameter comprises a lift gas rate, and wherein the program code is configured to determine a well-specific lift gas rate for the well by:
interpolate a stored set of gas lift performance curves for the well based upon a well head flowing pressure for the well to determine a current lift performance curve;
numerically differentiate the current lift performance curve to determine a performance curve slope at a plurality of points on the current lift performance curve and thereby generate a derivative performance curve; and
determine the well-specific lift gas rate from the derivative performance curve based upon the oilfield-wide slope control variable.

23. The computing device of claim 20, wherein the program code is further configured to constrain the lift parameter based upon a well-level constraint.

24. A system for performing field lift optimization for a plurality of wells in an oilfield, the system comprising:
a central controller configured to generate an oilfield-wide slope control variable based upon well-specific performance curves for the plurality of wells and communicate the oilfield-wide slope control variable to the plurality of wells;
a plurality of well controllers, each well controller associated with a well from among the plurality of wells and configured to receive the oilfield-wide slope control variable, wherein each well controller is further configured to generate a lift parameter for an artificial lift mechanism for such associated well based upon the oilfield-wide slope control variable and at least one well-specific performance curve for such associated well.

25. A computer readable storage medium having a set of computer-readable instructions residing thereon that, when executed, perform field lift optimization by causing at least one well among a plurality of wells in an oilfield to control a lift parameter associated with an artificial lift mechanism for the well in response to an oilfield-wide slope control variable, wherein the oilfield-wide slope control variable is usable to determine the lift parameter based upon at least one well-specific performance curve for the well.
